(19) United States
(12) Patent Application Publication
(10) Pub. No.: US 2019/0005556 A1
(43) Pub. Date: Jan. 3, 2019

(54) Off-Market Real Estate

(71) Applicant: Mike Chaffee, Kirkland, WA (US)

(72) Inventor: Mike Chaffee, Kirkland, WA (US)

(21) Appl. No.: 15/640,064

(22) Filed: Jun. 30, 2017

(51) Int. Cl. G06Q 30/06; G06Q 50/16; G06Q 50/32

(52) U.S. Cl. CPC G06Q 30/0613; G06Q 50/32; G06Q 50/16

(57) ABSTRACT

A potential buyer of a piece of real estate may desire specified criteria which may not be on the market. Specified criteria may include a style of home, such as a craftsman or modern, for example, house size, lot size, number of bedrooms, location, school district, neighborhood, or any other features. If an off-market house meets the desired criteria, an owner of the house may be approached and provided with an offer to purchase.

### FIELD

This disclosure relates to off-market real estate.

### BACKGROUND

People who wish to purchase homes often have particular features they are interested in. These features may not be available in homes on the market, leaving potential home purchasers frustrated in their efforts.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, techniques to locate houses that have some or all of the specified criteria that a potential home purchaser may desire.

Homes that have the specified criteria may not be on the market.

Specified criteria may include a style of home, such as a craftsman or modern, for example, house size, lot size, number of bedrooms, location, school district, neighborhood, or any other features. If an off-market house meets the desired criteria, an owner of the house may be contacted and provided with an offer to purchase.

### BRIEF DESCRIPTION OF THE DRAWINGS

The present description may be better understood from the following detailed description read in light of the appended drawings, wherein:

FIG. 1 is a block diagram illustrating an example of a system capable of supporting Off-Market Real Estate according to one embodiment.

FIG. 2 is a flow chart of an off-market real estate, according to one embodiment.

FIG. 3 illustrates how proximity filters may be configured, according to one embodiment.

FIG. 4 illustrates a data input screen supporting Off-Market Real Estate, according to one embodiment.

FIG. 5 is a block diagram illustrating an example computer according to one embodiment.

### DESCRIPTION

A more particular description of certain embodiments of the insect trap may be had by references to the embodiments shown in the drawings that form a part of this specification, in which like numerals represent like objects.

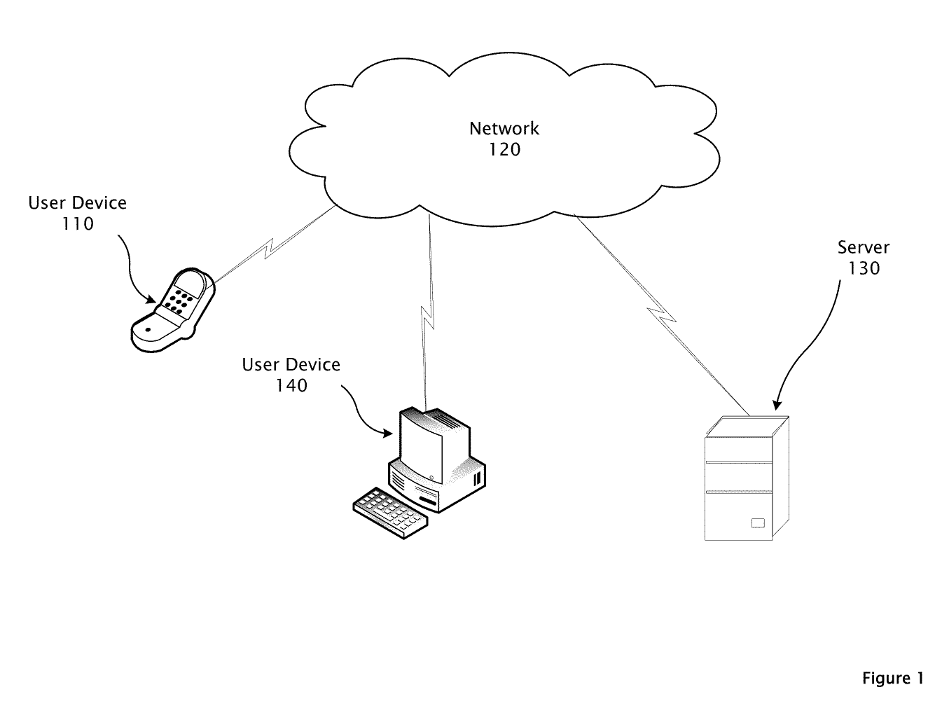

FIG. 1 is a block diagram illustrating an example of a system capable of supporting Off-Market Real Estate according to one embodiment.

Network 120 may include Wi-Fi, cellular data access methods, such as 3G or 4GLTE, Bluetooth, Near Field Communications (NFC), the Internet, local area networks, wide area networks, or any combination of these or other means of providing data transfer capabilities. In one embodiment, Network 120 may comprise Ethernet connectivity. In another embodiment, Network 120 may comprise fiber optic connections.

User Device 110, 140 may be a smartphone, tablet, laptop computer, and may have network capabilities to communicate with Server 130. User Device 110, 140 may also be a mobile device or a desktop computer, server, or other computing device.

Server 130 may include one or more computers, and may serve several roles. Server 130 may be conventionally constructed, or may be of a special purpose design for processing data relating to Off-Market Real Estate. A database of property information may be disposed on Server 130. Server 130 may be operated by the user, or by third party hosts. One skilled in the art will recognize that Server 130 may be of many different designs and may have different capabilities.

In one embodiment, User Device 110 may be used to find information about a property. Such a search may be based on location identifiers, such as school zone, zip code, city, or neighborhood, or by a price range, particular specifications, such as number of bedrooms or overall square footage, or a combination of two or more of such attributes. One having skill in the art will recognize that many different search criteria may be used to obtain a list of properties of interest.

Searches may be performed via an application on a mobile device, an application on a personal computer, or on a website. One having skill in the art will recognize that many techniques and technologies may be used to provide search capability.

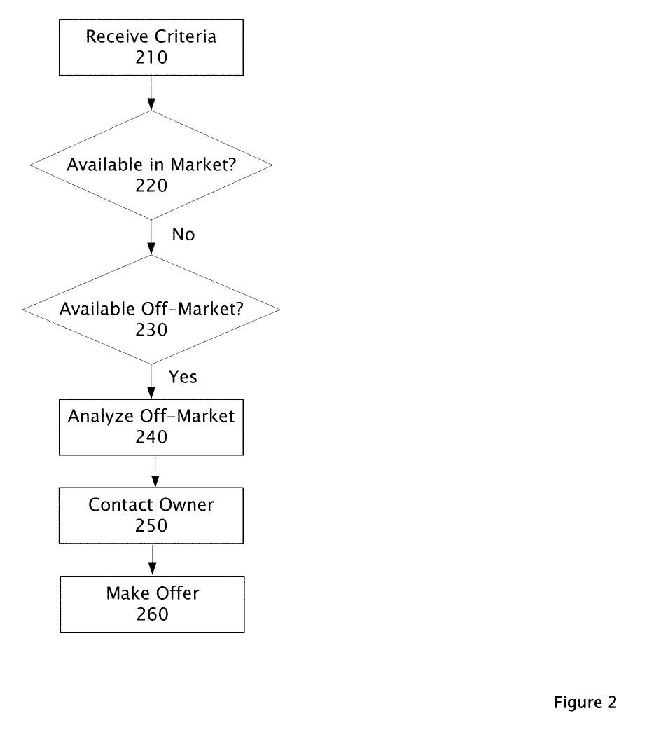

FIG. 2 is a flow chart of an off-market real estate, according to one embodiment. A user may Receive Criteria 210, describing features a potential buyer is looking for in a home. These features may include such criteria as a style of a house; craftsman, modern, country, or rambler, for example. A potential buyer may also want to specify, for example, lot size, house square footage, floor plan, location, school district, number of bedrooms, quality of build, garage size, zoning, access to public transportation, cost per square foot, overall price, proximity to a freeway, distance to a park, or many other attributes.

The user may search for houses Available in Market 220 to see if any meeting the potential buyer's specifications. If such a house is not available, the user may check to verify if one or more houses are Available Off-Market 230. If there is at least one house available, the user may Analyze Off-Market 240, which may include applying an additional filter. For example, houses that sold in the previous 18 months, or houses that back up to power lines or a freeway may be filtered out. One having skill in the art will recognize that other filters may also be considered.

Analyze Off-Market 240 may also include a determination of a probability that a house may sell. Factors entering that determination may include purchase price versus current value, length of time the current owner has owned the house, whether the current owner is looking for another house, or whether the owner owns more than one property. One having skill in the art will recognize that other factors may also be considered.

If at least one house is still available meeting the specifications and any additional filters, the user may Contact Owner 250. An owner may be contacted, for example by mailing a postcard to an address believed to be the owner's address. If the owner is interested, Make Offer 260 may include sending an offer to the owner. The offer may, for example, include information about a pre-approved mortgage for the potential buyers. In one embodiment, offers may be sent to all owners of any house that meets the criteria. In another embodiment, an offer may only be sent to one owner. In yet another embodiment, offers may be sent to a limited set of owners, for example the owners of three houses. This may allow owners to know that the potential buyers are serious about their house.

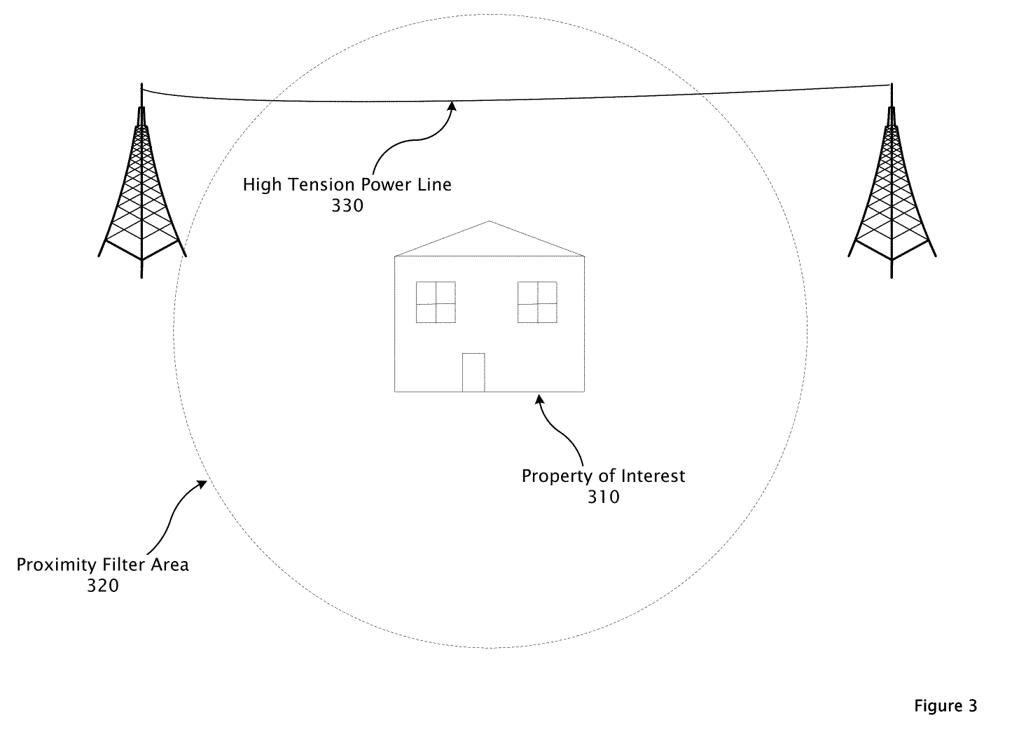

FIG. 3 illustrates how proximity filters may be configured, according to one embodiment. Property of Interest 310 may be selected based on meeting specifications. A filter may be applied to determine if Property of Interest 310 is within Proximity Filter Area of High Tension Power Line 330. In this example it is, so Property of Interest 310 may be excluded from consideration for a potential buyer. Proximity Filter Area 320 may be defined by a radius from Property of Interest 310, property survey data, a listing of landmarks, or any other way to indicate an area. Filters may, for example, exclude property with high tension power lines, freeways, swamps, or other items that an owner may not desire nearby. Alternatively, Proximity Filter Area 320 may be used for positive features, by determining if a green space, a park, a bus stop, or other features a potential buyer may want are nearby.

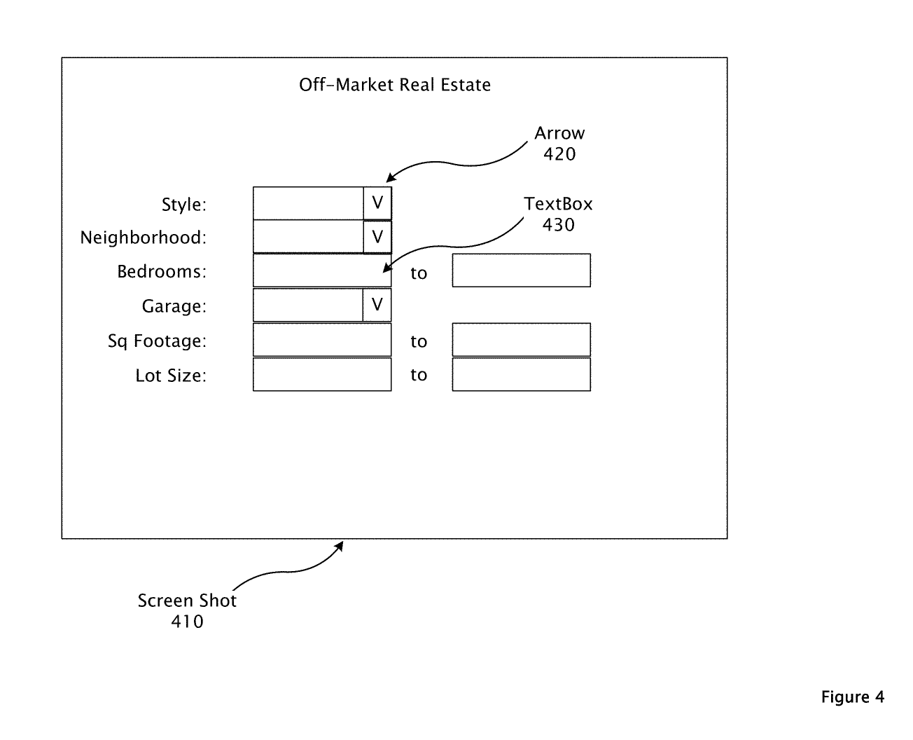

FIG. 4 illustrates a search criteria Screen Shot 410 supporting Off-Market Real Estate, according to one embodiment. A mobile application or a web application may allow input of various criteria which a potential buyer are interested in. In the example shown, house style, neighborhood, number of bedrooms, garage type, square footage, and lot size are illustrated. One having skill in the art will recognize that many other criteria may be searched for in such an application.

Some criteria may be selected from a list. For example, Style may be selected from, for example, daylight rambler, country, modern, two-story, or other types of styles of houses. Neighborhood and garage type may similarly be selected from a list of neighborhoods in an area. In this example, Arrow 420 may be used to indicate a list allowing a selection to be made may be accessed. Other fields, such as a range of number of bedrooms may simply allow two TextBox 430s to be entered with a lower and upper bound. In another embodiment, a slider control may be used. One having skill in the art will recognize that many different control types and screen layouts may be used to obtain selected criteria.

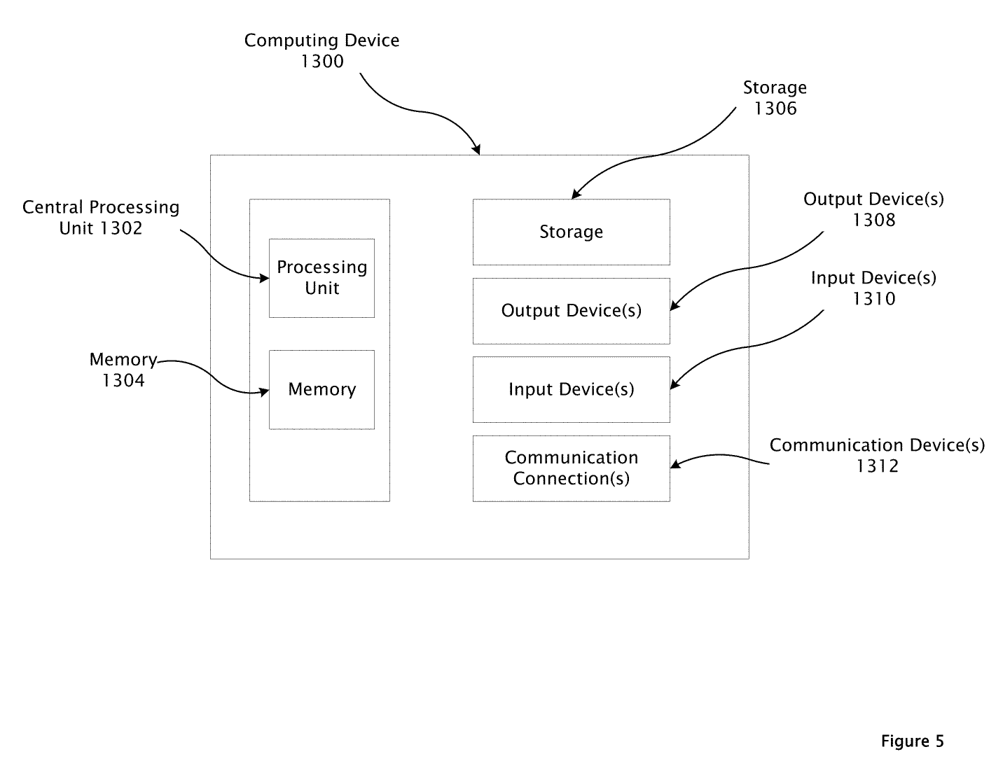

FIG. 5 illustrates a component diagram of a computing device according to one embodiment. The Computing Device (1300) can be utilized to implement one or more computing devices, computer processes, or software modules described herein, including, for example, but not limited to User Device 110, or a Server 130. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, or a Server 130. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302), also known as a processor, and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPUs in parallel.

Computing Device (1300) may also include additional storage (removable and/or non-removable) including, but not limited to, magnetic or optical disks or tape. Such additional storage is illustrated in FIG. 5 by Storage (1306). Computer storage media include volatile and nonvolatile, removable and non-removable media implemented in any method or technology for storage of information such as computer-readable instructions, data structures, program modules or other data. Memory (1304) and Storage (1306) are all examples of computer storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer-readable storage media may be part of computing device (1300). Computer-readable storage media does not include transient signals.

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A method of purchasing off-market property, comprising:
receiving, from a user device, criteria a potential buyer has for a property;
determining if a property that meets the criteria is available on the market;
determining if a property that meets the criteria is available off-market if a property that meets the criteria is not available on the market;
sending a first owner of a first property meeting the criteria a first postcard, the first postcard indicating a potential buyer is interested in the first property if a property meeting the criteria is available off-market; and
making an offer on the first owner's property.

2. The method of claim 1, further comprising sending a second owner of a second property meeting the criteria a second postcard indicating the potential buyer is interested in the second property.
